(19) United States
(12) Patent Application Publication
(10) Pub. No.: US 2008/0209814 A1
(43) Pub. Date: Sep. 4, 2008

(54) RETAINER ASSEMBLY

(76) Inventor: Timothy Tarjeft, Wyandotte, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 11/681,290

(22) Filed: Mar. 2, 2007

(51) Int. Cl. B60J 10/04

(52) U.S. Cl. 49/415

(57) ABSTRACT

An improved apparatus for limiting and guiding movement of a window glass panel in a motor vehicle door is provided that minimizes glass contact and drag forces, decouples the material choice between the body portion and guide piece to enable optimization in connection with both the body portion and guide piece, and enables finer tuning of the apparatus merely by incorporating guide pieces of various sizes than by requiring modification or replacement of the entire apparatus. The improved apparatus includes a body portion having a generally U-shaped cross-section, including a base and first and second opposing sides defining a channel. The first side has a pair of longitudinally spaced retaining cavities. The improved apparatus further includes a guide piece having first and second opposing ends that is removably coupled to the body portion by disposing the first and second opposing ends in the pair of retaining cavities, thereby forming an arc for contacting and stabilizing the window glass in a motor vehicle door.

### BACKGROUND OF INVENTION

a. Field of Invention

The invention relates generally to a moving glass guide structure, and in particular, to a glass guide structure mounted in a door assembly of a vehicle such as an automotive vehicle to guide and limit movement of a window glass within the door assembly.

b. Description of Related Art

All automotive door constructions include a lower portion, while most, but not all, applications include an upper portion. The upper portion is the opening that houses the glass in the up position and conversely provides the fresh air opening when glass is in the down position. The lower portion houses the glass in the down position, along with the majority of door system mechanisms and trim. The upper and lower door boundary is defined as the beltline. This is the area and opening where the moving glass travels from the lower to upper door and vice versa. Most automotive doors have a body envelope created by an inner and outer door panel forming the main body of the door. A window regulator is provided for selectively moving the glass panel in and out of the body envelope to open and close the window opening of the door. Retainer assemblies can be disposed spanning above and below the belt line, exclusively above the belt line, or exclusively below the belt line. The retainer assemblies can be interposed between the inner and outer door panels at front and rear positions of the main body of the door and guide the front and rear ends of the glass panel when the glass panel ascends or descends. Retainer assemblies are further provided to limit and dampen glass panel cross car and fore/aft movement.

Conventional retainer assemblies comprise a main body defining a channel. Contact members can be integral to the inner surface of the main body and extend into the channel or may comprise flexible lips that are applied to the main body and that extend the entire length of the retainer. Conventional retainer assemblies comprise a rigid thermoplastic or metal in order to provide the required support and stability for the main body of the retainer assembly. These conventional integral type retainer assemblies have a number of deficiencies. First, contact members comprising a rigid thermoplastic result in rigid glass contact points. Since both glass and contact points are rigid, a balance between controlling glass movement, while minimizing glass drag forces is difficult, if not impossible to achieve. Moving glass, and indirectly the remaining glass guidance system, may be subjected to these conditions. The potentials are undesirable drag forces, and at the other extreme, rattles. Second, for integrated contact member versions, the material choices for the main body and contact members are necessarily constrained to be the same. Accordingly, the selected material must provide adequate characteristics for both the main body and the contact members and may not be optimized with respect to either piece of the retainer assembly (i.e., compromises must be made). Third, if the extent of projection of a contact member or degree of angling of a contact member has to be modified to provide optimal guidance and damping functions, the entire retainer assembly must be modified or replaced.

Accordingly, there remains a need for a retainer assembly that minimizes and/or eliminates these deficiencies in the prior art.

### SUMMARY OF INVENTION

The present invention provides an apparatus for limiting and guiding window glass movement in a motor vehicle door. The apparatus may include a body portion extending along a longitudinal axis and having a generally U-shaped cross section. The body portion may include a base and first and second opposing sides each extending from the base defining a channel. The first side may have a pair of longitudinally spaced retaining cavities. The apparatus may further include a guide piece having first and second opposing ends. The guide piece may be removably coupled to the body portion by disposing the first and second ends in the pair of retaining cavities, thereby forming an arc extending into the channel for contacting and stabilizing the window glass.

An apparatus for limiting and guiding movement of a window glass in a motor vehicle in accordance with the present invention is advantageous as compared to existing apparatuses for limiting and guiding window glass movement in a motor vehicle. First, the inventive apparatus retains the necessary structural characteristics of a rigid thermoplastic apparatus, while minimizing the glass contact and drag forces. Second, because the guide pieces of the inventive apparatus are removable from the body portion, the material chosen for the body portion may be different from the material chosen for the guide pieces, such that the material choice between the body portion and guide pieces is decoupled and may be optimized for the particular functions of each. That is, the apparatus offers a rigid body (retainer) structural characteristics while providing the benefits of localized flexible stabilizing features due to appropriate material selection for the guide piece. Third, multiple variations of guide pieces can be incorporated into the body portion to offer finer tuning of the apparatus, rather than requiring that an entire apparatus be modified or replaced in order to provide optimal guidance and damping functions. Fourth, less lead time may be required to modify tooling when using removable guide pieces for fine tuning. Fifth, less material may be used in connection with the inventive apparatus than with a flexible lip that may extend the entire length of the retainer in some designs, thereby resulting in an overall cost savings.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention and together with the detailed description serve to explain the principles of the invention. In the drawings:

FIG. 1 is a perspective view of an apparatus in accordance with the present invention.

FIG. 2 is a cross-sectional view of a body portion with the guide pieces installed taken substantially along line 2-2 of FIG. 1.

FIG. 3 is a side view of a guide piece in an unflexed position for use in an apparatus in accordance with the present invention.

FIG. 4 is a side view of a guide piece in a flexed position suitable for installation and use in an apparatus in accordance with the present invention.

FIGS. 5A-5B are side views, with portions broken away and cross-sectioned, of exemplary embodiments of an apparatus in accordance with the present invention showing a glass panel that may be stabilized by the apparatus.

### DETAILED DESCRIPTION OF THE PREFERRED EMBODIMENT

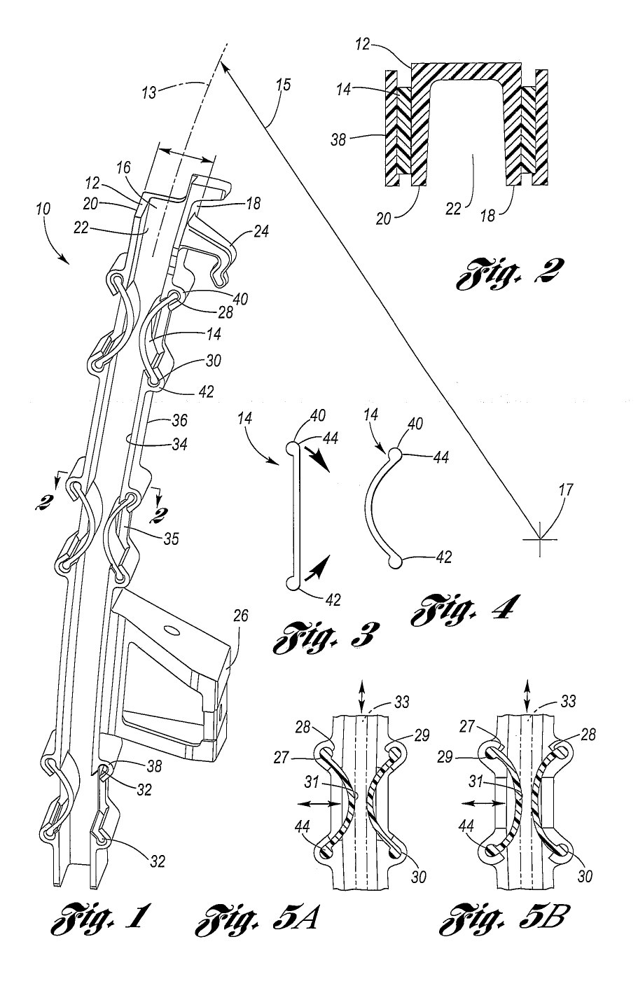

Referring now to the drawings wherein like reference numerals designate corresponding parts throughout the several views, FIG. 1 illustrates the inventive apparatus 10 for limiting and guiding window glass movement in a motor vehicle door. The inventive apparatus 10 comprises a body portion 12 and a guide piece 14. Although the invention is described in connection with limiting and guiding window glass movement in a motor vehicle door, it will be appreciated by those of ordinary skill in the art that the inventive apparatus may also have uses in numerous other applications. For example, the apparatus may be used in the aerospace industry (e.g., window) or in connection with the transportation of fragile components (i.e., fragile component may be stabilized laterally by the use of the invention during transport), or any other application in which shock absorption and vibration dampening features are advantageous.

Body portion 12 may provide a rigid structure for attachment of apparatus 10 to a vehicle door. Body portion 12 may comprise a rigid, molded thermoplastic. For example only, body portion 12 may comprise polypropylene or nylon. Although these materials are mentioned in detail, it is understood by those of ordinary skill in the art that various other materials may be used for body portion 12 and remain within the spirit and scope of the invention. It should be understood that the configuration of body portion 12 may be adapted to accept varying curved or straight arrangements of window glass panels or other objects. Body portion 12 extends generally along a radius designated 13, having a length 15, taken relative to point 17. As best viewed in FIGS. 1-2, body portion 12 has a generally U-shaped cross section, including base 16 and first and second opposing sides 18, 20 each extending from base 16 at generally right angles. Base 16 and first and second opposing sides 18, 20 define a channel 22.

Body portion 12 may further include an integrally formed first member 24 for upper attachment of body portion 12 to the motor vehicle door. First member 24 may comprise a curved, longitudinally extending hook in an exemplary embodiment. Body portion 12 may further include an integrally formed second member 26 for lower attachment of body portion 12 to the motor vehicle door. Second member 26 may comprise parallel transversely extending projections connected by a bridge in an exemplary embodiment. Although these first and second attachment members 24, 26 are described in detail, it is understood by those of ordinary skill in the art that various other attachment members may be provided and remain within the spirit and scope of the invention.

An inner surface of first and second opposing sides 18, 20 (i.e., facing channel 22) may include openings at various longitudinal points as shown in FIG. 1. In alternative embodiments, first and second opposing sides 18, 20 may also extend continuously in the longitudinal direction. First and second opposing sides 18, 20 may also include at least a portion of sides 18, 20 extending continuously in the longitudinal direction with openings at various longitudinal points. Although these configurations are described in detail, it is understood by those of ordinary skill in the art that various configurations may be used for first and second opposing sides 18, 20 and remain within the spirit and scope of the invention. As will be described in greater detail below, the spaced openings, in the illustrated embodiment, provide a window through which the flexible, convex arc shaped guide pieces extend into channel 22.

First side 18 includes generally cylindrical shaped projections 38 having associated therewith a corresponding pair of longitudinally spaced, centrally disposed retaining cavities 28, 30, which may be provided to receive guide piece 14. Although described as a cylindrical projection, it is understood by those of ordinary skill in the art that projection 28 may comprise any number of various shapes and remain within the spirit and scope of the invention. Each retaining cavity 28, 30 may comprise a bore 32 extending a predetermined depth from a first longitudinal edge 34 of first side 18 to a second longitudinal edge 36. Retaining cavities 28, 30 may be located on first side 18 proximate a first end of apparatus 10 in an exemplary embodiment. Retaining cavities 28, 30 may also be located on second side 20 proximate a first end of apparatus 10 in an exemplary embodiment. Retaining cavities 28, 30 located on first side 18 and on second side 20 may be directly opposite to each other in an exemplary embodiment in order to provide comparably equal and opposing guiding forces on the glass panel. First side 18 may include a plurality of longitudinally spaced pairs of retaining cavities 28, 30 in an exemplary embodiment. For example, FIG. 1 shows three pairs of longitudinally spaced retaining cavities 28, 30 located on first side 18. Second side 20 may include a corresponding plurality of longitudinally spaced pairs of retaining cavities 28, 30 in an exemplary embodiment. For example, FIG. 1 shows three pairs of longitudinally spaced retaining cavities 28, 30 located on second side 20. Again, each pair of retaining cavities 28, 30 located on a first side 18 and on second side 20 may be directly opposite to each other in an exemplary embodiment. Each pair of retaining cavities 28, 30 may be located at pre-selected locations on first side 18 of body portion 12. Each pair of retaining cavities 28, 30 may be located at pre-selected locations on second side 20 of body portion 12. Although these numbers and configurations of retaining cavities 28, 30 are described in detail, it is understood by those of ordinary skill in the art that any number of pairs of retaining cavities 28, 30 or configuration of pairs of retaining cavities 28, 30 may be used and remain within the spirit and scope of the invention. The number and configuration of pairs of retaining cavities 28, 30 may be modified in order to accommodate objects of various sizes and shapes. As shown, the pairs are substantially equally spaced.

Guide piece 14 may be provided to limit and dampen window glass panel cross car movement (i.e., movement within channel 22 between sides 18, 20) and also to guide and stabilize a window glass panel as it moves vertically in a motor vehicle door. Guide piece 14 may comprise a molded or extruded flexible or elastomeric material. For example only, guide piece 14 may comprise neoprene, rubber, polyvinyl chloride (PVC), thermoplastic vulcanizate (TPV), or ethylene propylene diene rubber (EPDM). Although these materials are mentioned in detail, it is understood by those of ordinary skill in the art that various other materials may be used for guide piece 14 and remain within the spirit and scope of the invention. In another embodiment, guide piece 14 may comprise a rigid material. In another exemplary embodiment, guide piece may comprise a dual durometer material, such that first and second opposing ends 40, 42, as referenced below, may comprise a higher durometer material, while the remainder of guide piece 14 may comprise a lower durometer material, in order to facilitate assembly of apparatus 10. In an exemplary embodiment, at least a portion of at least one face of guide piece 14 may be smooth. In another exemplary embodiment, at least a portion of at least one face of guide piece 14 may include a coating with a low coefficient of friction to reduce friction between guide piece 14 and glass window panel. For example only, the coating may comprise flocking. In other exemplary embodiments, at least a portion of at least one face of guide piece 14 may include grooves, ridges, or texturing to further improve performance of apparatus 10 by reducing friction between guide piece 14 and glass window panel, by reducing material as a cost savings, and by providing a visual means of identifying various types of guide pieces 14 that may be utilized in connection with apparatus 10.

As best viewed in FIG. 3, guide piece 14 may be generally rectangular in shape and generally flat before being flexed and coupled to body portion 12. In another embodiment, guide piece 14 may be curved before coupling to body portion 12 in order to ease assembly of apparatus 10. The degree of curvature of guide piece 14 may vary depending upon the desired amount of contact between guide piece 14 and the glass window panel. Guide piece 14 includes first and second opposing ends 40, 42. First and second ends 40, 42 may each include a raised lip 44. Raised lip 44 may extend along an entire edge of first end 40 or second end 42. Raised lip 44 may be configured in shape to engage bore 32 of retaining cavities 28, 30 that is defined by projection 38. As shown in FIGS. 1 and 3-5, lips 44 may be hemispherical in shape or profile to correspond with the shape or profile of retaining cavities 28, 30. Although a hemispherical lip 44 is mentioned in detail, it is understood by those of ordinary skill in the art that lip 44 could comprise any number of shapes or profiles, including but not limited to, square, triangular, flanged, or tapered shapes or profiles and remain within the spirit and scope of the invention. Accordingly, it is also understood by those of ordinary skill in the art that the corresponding retaining cavities 28, 30 of body portion 12 could comprise any number of shapes or profiles, including but not limited to, square, triangular, flanged, or tapered shapes or profiles and remain within the spirit and scope of the invention. The length of guide piece 14 from first end 40 to second end 42 may be modified in order to provide more or less contact between guide piece 14 and the glass window panel. Accordingly, the inventive apparatus may provide extensive versatility for adjusting the amount of contact between the inventive apparatus 10 and the glass window panel for fine tuning of the apparatus 10.

Referring now to FIGS. 3-4, guide piece 14 may be configured to be flexed or formed into a convex arc by applying pressure to first and second ends 40, 42 toward the center of guide piece 14. Referring again to FIG. 1, guide piece 14 may be removably coupled to body portion 12 by disposing first and second ends 40, 42 in retaining cavities 28, 30, respectively, such that guide piece 14 forms a convex arc that extends into channel 22. A guide piece 14 may be disposed in more than one pair of retaining cavities 28, 30. Referring now to FIG. 1, a guide piece 14 is shown disposed in two pairs of retaining cavities 28, 30 on first side 18. One of the pairs of retaining cavities 28, 30 is shown without guide piece 14. FIGS. 3-4 illustrate guide piece 14 that may be configured to be disposed in the empty retaining cavities 28, 30. Referring again to FIG. 1, a guide piece 14 is shown disposed in three pairs of retaining cavities 28, 30 on second side 20. The convex arcs may be configured to contact a window glass panel disposed in the motor vehicle door to provide both shock absorbing and guidance features for apparatus 10. Guide piece 14 may be prevented from moving within retaining cavities 28, 30. For example, longitudinal wall 35 may retain guide piece 14 within retaining cavities 28, 30. Further, a ridge disposed within retaining cavities 28, 30 may retain guide piece 14 within retaining cavities 28, 30. In an exemplary embodiment, ends 40, 42 of guide piece 14 may be compressed for insertion into retaining cavities 28, 30 in an interference fit. In another exemplary embodiment, projection 38 defining bore 32 may be spread apart for receiving guide piece 14 in an interference fit.

Referring now to FIGS. 5A-5B, retaining cavities 28, 30 may be defined by a generally flat section 27 and a hemispherical section 29. Lips 44 of guide piece 14 may be shaped in a way that is complementary to retaining cavities 28, 30. For example, a first side of guide piece 14 may be generally flat and mate with flat section 27. A second side of guide piece 14 may include lips 44 that are hemispherical in shape and mate with hemispherical section 29. The shape of lips 44 of guide piece 14 may assist in ensuring that guide piece 14 is only installed in body portion 12 in a particular orientation. Because retaining cavities 28, 30 and lips 44 of guide piece 14 are complementary, lips 44 serve to retain and define the orientation of guide piece 14 relative to body portion 12 of apparatus 10. Although a generally flat section 27 and a hemispherical section 29 for retaining cavities 28, 30 are mentioned in detail, as described above it is understood by those of ordinary skill in the art that retaining cavities 28, 30 may comprise any number of shapes and profiles and remain within the spirit and scope of the invention. Similarly, although a flat side and hemispherical lip 44 for guide piece 14 are mentioned in detail, as described above it is understood by those of ordinary skill in the art that guide piece 14 may comprise any number of shapes and profiles and remain with the spirit and scope of the invention, so long as the shape and profile of retaining cavities 28, 30 and guide piece 14 are complementary. In another exemplary embodiment, guide piece 14 may be color coded to ensure installation in body portion 12 in a particular orientation relative to body portion 12 of apparatus 10.

In an exemplary embodiment, the retaining cavities 28, 30 defined by projection 38 of body portion 12 may be configured to receive guide pieces 14 in the orientation illustrated in FIGS. 1 and 5A (i.e., lips 44 of opposing guide pieces 14 each extending inwardly toward channel 22). In another exemplary embodiment, the retaining cavities 28, 30 defined by projection 28 of body portion 12 may be configured to receive guide pieces 14 in an alternate orientation illustrated in FIG. 5B (i.e., lips 44 of opposing guide pieces 14 each extending outwardly away from channel 22).

Referring to FIGS. 5A-5B, when guide piece 14 is seated in retaining cavities 28, 30, the convex arc contacts the window glass panel 33 at point 31. The convex arc, thus formed and installed, provides a resilient member, like a stiff spring, to control lateral forces that the window glass panel imposes on the convex arc. The ends 40, 42 of the guide piece 14 are anchored due to the shape of retaining cavities 28, 30. Accordingly, the guide piece 14 may be locked into the retaining cavities 28, 30. The guide piece 14 may also be relatively immune to longitudinal forces applied by the window glass panel since the distal ends of the ends 40, 42 dead head into the corner of retaining cavities 28, 30.

An apparatus for limiting and guiding window glass movement in a motor vehicle door in accordance with the present invention has many advantages as compared to conventional apparatuses for limiting and guiding movement of a window glass in a motor vehicle. First, the inventive apparatus retains the necessary structural characteristics of a rigid thermoplastic apparatus, while minimizing the glass contact and drag forces. Second, because the guide pieces of the inventive apparatus are removable from the body portion, the material chosen for the body portion may be different from the material chose for the guide pieces, such that the material choice between the body portion and guide pieces is decoupled and may be optimized for the particular functions of each. Third, multiple variations of guide pieces can be incorporated into the body portion to offer finer tuning of the apparatus, rather than requiring that an entire apparatus, including the body portion, be removed and modified or replaced in order to provide optimal guidance and damping function. For example, different size guide pieces can be used to accommodate different thickness window glass panel. Different material for guide pieces can provide a different degree of resiliency. Fourth, the use of the inventive apparatus may decrease the time and expense associated with modifying tooling to accommodate modified apparatuses. Fifth, the use of the inventive apparatus may result in overall cost savings by avoiding the use of a flexible lip that may extend the entire length of a retainer both above and below a belt line of a vehicle.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. An apparatus for limiting and guiding window glass movement in a motor vehicle door, comprising:
a body portion having a generally U-shaped cross-section, said body portion including a base and first and second opposing sides defining a channel, said first side having a pair of longitudinally spaced retaining cavities; and
a guide piece having first and second opposing ends, said guide piece removably coupled to said body portion by disposing said first and second opposing ends in said pair of retaining cavities, thereby forming an arc for contacting and stabilizing said window glass.

2. An apparatus in accordance with claim 1, wherein said second side includes a pair of longitudinally spaced retaining cavities.

3. An apparatus in accordance with claim 1, wherein said first side includes a plurality of pairs of longitudinally spaced retaining cavities.

4. An apparatus in accordance with claim 2, wherein said second side includes a plurality of pairs of longitudinally spaced retaining cavities.

5. An apparatus in accordance with claim 1, wherein said body portion comprises a thermoplastic.

6. An apparatus in accordance with claim 1, wherein said body portion is rigid.

7. An apparatus in accordance with claim 3, wherein each of said plurality of pairs of longitudinally spaced retaining cavities are located at pre-selected locations on said first side of said body portion along a longitudinal axis of said body portion.

8. An apparatus in accordance with claim 4, wherein each of said plurality of pairs of longitudinally spaced retaining cavities are located at pre-selected locations on said second side of said body portion along a longitudinal axis of said body portion.

9. An apparatus in accordance with claim 1, wherein said guide piece comprises an elastomeric material.

10. An apparatus in accordance with claim 1, wherein said guide piece is generally rectangular in shape before being coupled to said body portion.

11. An apparatus in accordance with claim 1, wherein said guide piece is generally flat before being coupled to said body portion.

12. An apparatus in accordance with claim 1, wherein said first and second opposing ends of said guide piece each include a raised lip.

13. An apparatus in accordance with claim 12, wherein first and second raised lips extend along an entire edge of said first and second ends of said guide piece.

14. An apparatus in accordance with claim 12, wherein each of said retaining cavities is configured to receive said raised lip.

15. An apparatus in accordance with claim 1, wherein said guide piece is configured to be formed into said arc.

16. An apparatus in accordance with claim 1, wherein said arc extends convexly into said channel.

17. An apparatus in accordance with claim 1, wherein said body portion comprises a first member for attachment of said body portion to said door.

18. An apparatus in accordance with claim 13, wherein said body portion comprises a second member for attachment of said body portion to said door.

19. An apparatus for retaining and limiting movement of an object, comprising:
a body portion having a generally U-shaped cross-section, said body portion including a base and first and second opposing sides defining a channel, said first side having a first pair of longitudinally spaced retaining cavities and said second side having a second pair of longitudinally spaced retaining cavities;
a first guide piece having first and second opposing ends, said first guide piece removably coupled to said body portion by disposing said first and second opposing ends of said first guide piece in said first pair of retaining cavities, thereby forming a first arc; and
a second guide piece having first and second opposing ends, said second guide piece removably coupled to said body portion by disposing said first and second opposing ends of said second guide piece in said second pair of retaining cavities, thereby forming a second arc,
wherein a lateral gap between said opposing first and second arcs is configured to receive and stabilize said object.

20. An apparatus in accordance with claim 19, wherein a first side of said first guide piece and said second guide piece is flat and wherein a second side of said first guide piece and said second guide piece include at least one raised lip for ensuring proper orientation of said first and second guide pieces in said first and second pairs of retaining cavities.
